(19) United States
(12) Patent Application Publication
(10) Pub. No.: US 2020/0251964 A1
(43) Pub. Date: Aug. 6, 2020

(54) MOTOR AND AIR BLOWING DEVICE

(71) Applicant: NIDEC CORPORATION, Kyoto (JP)

(72) Inventors: Yoshitsugu SASAGURI, Kyoto (JP); Yusuke WATANABE, Kyoto (JP); Sho FUKUHARA, Kyoto (JP); Kazuya TAKEDA, Kyoto (JP); Yuki KANAZAWA, Kyoto (JP)

(73) Assignee: NIDEC CORPORATION, Kyoto (JP)

(21) Appl. No.: 16/719,912

(22) Filed: Dec. 18, 2019

(30) Foreign Application Priority Data
Jan. 31, 2019 (JP) 2019-015887

(51) Int. Cl. H02K 11/028; H02K 1/27; H02K 1/28; H02K 7/14; H02K 11/215; H02K 21/22; F04D 19/00; F04D 13/06

(52) U.S. Cl. CPC H02K 11/028; H02K 1/2786; H02K 1/28; F04D 13/06; H02K 11/215; H02K 21/22; F04D 19/002; H02K 7/14

(57) ABSTRACT

A motor includes a rotor which is rotatable with a central axis that extends vertically as a center and in which a rotor magnet is disposed; a stator which faces the rotor in a radial direction; and a position detection part which is located on one side of an axial direction of the rotor magnet and which detects a magnetic flux of the rotor magnet, wherein in the rotor magnet, magnetization regions magnetized with different polarities are alternately disposed in a circumferential direction, and the rotor includes a shield member which faces, in an axial direction, a part of the rotor magnet on the one side of the axial direction.

### CROSS REFERENCE TO RELATED APPLICATIONS

The present invention claims priority under 35 U.S.C. § 119 to Japanese Application No. 2019-015887 filed Jan. 31, 2019, and the entire content of which is incorporated herein by reference.

### BACKGROUND

### Technical Field

The disclosure relates to a motor and an air blowing device.

### Description of Related Art

In a conventional outer rotor type motor, in many cases, a plurality of electromagnetic steel plates is laminated and formed, and a permanent magnet is fixed to a concave-shaped groove part provided on an inner-radial-side circumferential surface of a rotor core. Then, in many cases, among the plurality of electromagnetic steel plates, only at least one electromagnetic steel plate disposed on the rotor side in the rotational axis direction often has a surface protruding into the groove part on the inner-radial-side circumferential surface. Further, in many cases, at least a part of the rotor-side end surface of the permanent magnet contacts the protruding surface, thereby positioning the rotational axis direction of the permanent magnet.

In addition, in some cases, the protruding surface is in a shape that fits in the groove part, and even if the protruding surface is provided, there is little influence of short-circuiting the magnetic path of the permanent magnet, and it may be difficult to reduce the magnetic flux of the permanent magnet.

In a conventional brushless motor, the magnetic flux from the permanent magnet is detected, and the position of the rotor is detected based on the change of the detected magnetic flux. Then, the rotation of the rotor is controlled based on the position of the rotor. However, in the conventional brushless motor, the magnetic flux of the permanent magnet is difficult to change, and it is difficult to accurately detect the position of the rotor.

### SUMMARY

### Solution to the Problem

An exemplary motor of the disclosure includes a rotor which is rotatable with a central axis that extends vertically as a center and in which a rotor magnet is disposed; a stator which faces the rotor in a radial direction; and a position detection part which is located on one side of an axial direction of the rotor magnet and which detects a magnetic flux of the rotor magnet, wherein in the rotor magnet, magnetization regions magnetized with different polarities are alternately disposed in a circumferential direction, and the rotor includes a shield member which faces, in an axial direction, a part of the rotor magnet on the one side of the axial direction of the rotor magnet.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a perspective view showing an example of the air blowing device according to the disclosure.

FIG. 2 is a longitudinal sectional view of the air blowing device shown in FIG. 1.

FIG. 3 is an exploded perspective view of the rotor.

FIG. 4 is a perspective view of a part of the rotor as viewed from below.

FIG. 5 is an enlarged bottom view of the rotor.

FIG. 6 is a cross-sectional view of the rotor shown in FIG. 5 taken along the VI-VI line.

FIG. 7 is a cross-sectional view of the rotor shown in FIG. 5 taken along the VII-VII line.

FIG. 8 is an exploded perspective view of the rotor according to a modified example of the embodiment.

FIG. 9 is a perspective view of a part of the rotor shown in FIG. 8 as viewed from below.

### DESCRIPTION OF THE EMBODIMENTS

Hereinafter, exemplary embodiments of the disclosure will be described in detail with reference to the drawings. In this specification, a direction parallel to a central axis Cx of an air blowing device A is referred to as an “axial direction.” Further, in the axial direction, a direction going from a stator core 21 toward bearings 3 is referred to as an “axial-direction upper side,” and a direction going from the bearings 3 toward the stator core 21 is referred to as an “axial-direction lower side.” Furthermore, regarding surfaces of each component, a surface facing the axial-direction upper side is referred to as an “upper surface,” and a surface facing the axial-direction lower side is referred to as a “lower surface.”

Further, a direction orthogonal to the central axis Cx is referred to as a “radial direction.” Then, in the radial direction, a direction going toward the central axis Cx is referred to as a “radial-direction inner side,” and a direction going away from the central axis Cx is referred to as a “radial-direction outer side.” Furthermore, regarding side surfaces of each component, a surface facing the radial-direction inner side is referred to as an “inner side surface,” and a surface facing the radial-direction outer side is referred to as an “outer side surface.”

Further, a direction along an arc with the central axis Cx as the center is referred to as a “circumferential direction.” In addition, the above-described names of directions and surfaces are used for description, and do not limit the positional relationships and directions of the air blowing device A and a motor 200 in use.

<1. Regarding the Air Blowing Device A>

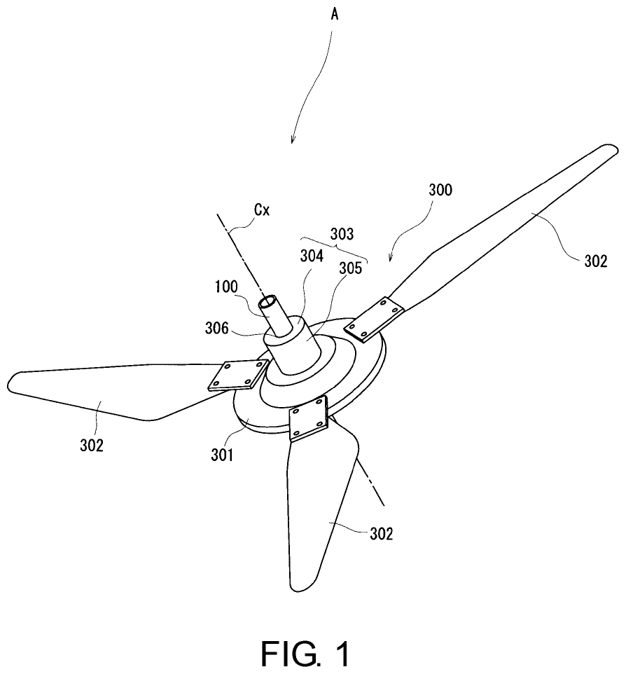

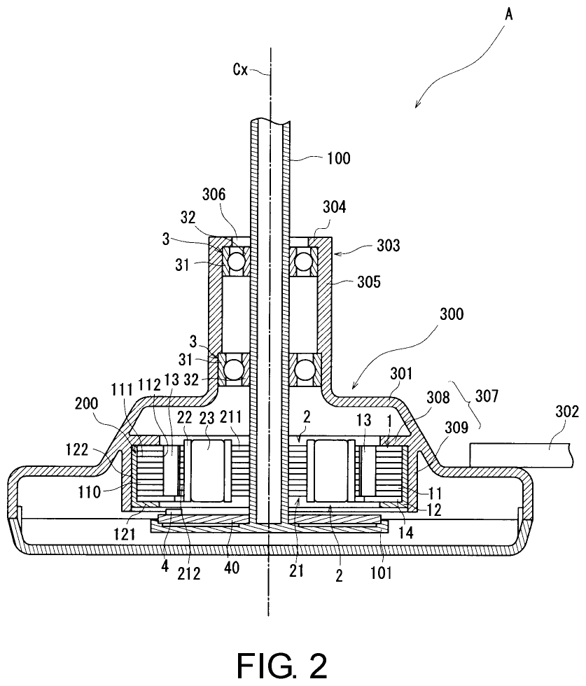

FIG. 1 is a perspective view showing an example of the air blowing device A according to the disclosure. FIG. 2 is a longitudinal sectional view of the air blowing device A shown in FIG. 1. As shown in FIG. 1 and FIG. 2, the air blowing device A according to the embodiment is a ceiling fan.

The air blowing device A includes a supporting column 100, the motor 200, and an impeller 300. The impeller 300 is attached to the supporting column 100 via the bearings 3 and is rotated by driving of the motor 200. The rotation of the impeller 300 generates an airflow going toward the axial-direction lower side. That is, the air blowing device A is an axial flow fan that generates an airflow from the axial-direction upper side to the lower side.

<2. Regarding the Supporting Column 100>

The supporting column 100 is disposed along the central axis Cx that extends vertically. The supporting column 100 is, for example, a member in a cylindrical shape configured by metal. A lead wire (not shown) connected to a circuit board 40 (to be described later) provided in the motor 200 is disposed in the inner part of the supporting column 100. In addition, the supporting column 100 may be configured by a material other than metal, such as ceramic or the like.

The supporting column 100 is fixed to the ceiling (not shown) of a living room. A base part 101 is provided on the axial-direction lower-side end part of the supporting column 100. The base part 101 expands in the radial direction and is disposed on the axial-direction lower-side end part of the supporting column 100. In addition, the base part 101 may be formed integrally with the supporting column 100 or may be configured to be attached to the supporting column 100. Further, the circuit board 40 is attached to the base part 101. A position detection part 4 is mounted on the upper surface of the circuit board 40.

<3. Regarding the Impeller 300>

As shown in FIG. 1 and FIG. 2, the impeller 300 includes an impeller housing 301 and a plurality of blades 302. The impeller 300 generates an airflow from the axial-direction upper side to the lower side. The impeller housing 301 is rotatably supported by the supporting column 100 via the bearings 3. Further, the impeller housing 301 has a space in the inner part, and a part of the supporting column 100 and the motor 200 are disposed in the inner part of the impeller housing 301.

The plurality of blades 302 are disposed on the upper surface of the impeller housing 301. The plurality of blades 302 are arranged in the circumferential direction. In the air blowing device A of the embodiment, the blades 302 are arranged on the upper surface of the impeller housing 301 at equal intervals. The impeller 300 of the embodiment includes three blades 302, but it is not limited thereto, and the impeller 300 may include four or more blades 302, or may include two or less blades 302.

The impeller housing 301 includes a bearing attachment part 303 on the axial-direction upper-side end part. The bearing attachment part 303 is rotatably attached to the supporting column 100 by two bearings 3 that are disposed apart in the axial direction. The bearing attachment part 303 is in a covered cylindrical shape. The bearing attachment part 303 includes a lid part 304 and a body part 305. The lid part 304 is provided on the axial-direction upper-side end part and expands in the radial direction. The body part 305 is in a cylindrical shape extending from the radial-direction outer edge of the lid part 304 toward the axial-direction lower side.

The lid part 304 includes, in a radial-direction central part, a through hole 306 penetrating in the axial direction. The supporting column 100 penetrates the through hole 306. The bearings 3 are disposed in the inner part of the bearing attachment part 303. In the embodiment, the bearings 3 are ball bearings. The supporting column 100 is fixed to inner rings 32 of the bearings 3. Outer rings 31 of the bearings 3 are fixed to the inner side surface of the body part 305. In this way, the impeller housing 301 is rotatably supported by the supporting column 100 via the bearings 3.

A rotor attachment part 307 in a covered cylindrical shape is provided in the inner part of the impeller housing 301. The rotor attachment part 307 is manufactured integrally with the impeller housing 301. The rotor attachment part 307 includes a rotor attachment lid part 308 and a rotor attachment cylinder part 309. The rotor attachment lid part 308 is in a circular plate shape that expands in a direction orthogonal to the central axis Cx on the axial-direction upper-side end part. The rotor attachment cylinder part 309 extends from the radial-direction outer-side edge part of the rotor attachment lid part 308 toward the axial-direction lower side. A rotor 1 is fixed to the rotor attachment part 307. More specifically, a rotor housing 12 (to be described later) including a rotor core 11, a rotor magnet 13 and a shield member 14 (to be described later) inside is fixed to the rotor attachment part 307.

<4. Regarding the Motor 200>

Next, a configuration of the motor 200 will be described. As shown in FIG. 2, the motor 200 includes the rotor 1, a stator 2, and the position detection part 4. The rotor 1 is rotatable with the central axis Cx that extends vertically as the center, and a rotor magnet 13 is disposed in the rotor 1. The stator 2 faces the rotor 1 in the radial direction. The position detection part 4 is located on one side of an axial direction of the rotor magnet 13 and detects a magnetic flux of the rotor magnet 13. The details of each part of the rotor 1, the stator 2, and the position detection part 4 are described below. The stator 2 of the motor 200 faces the inner circumferential surface of the rotor 1 in the radial direction. That is, the motor 200 is an outer rotor type brushless motor.

<4.1 Regarding the Rotor 1>

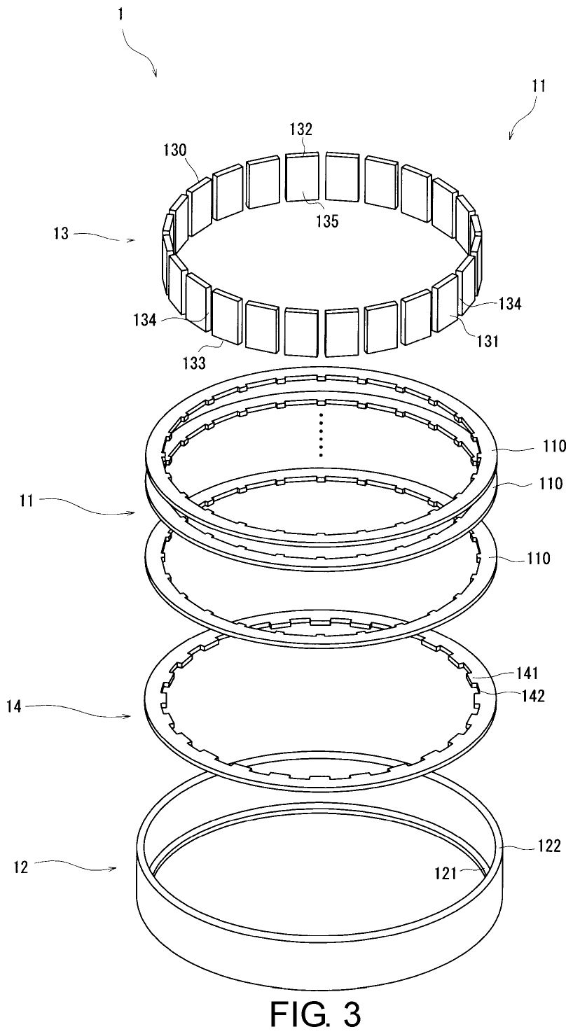

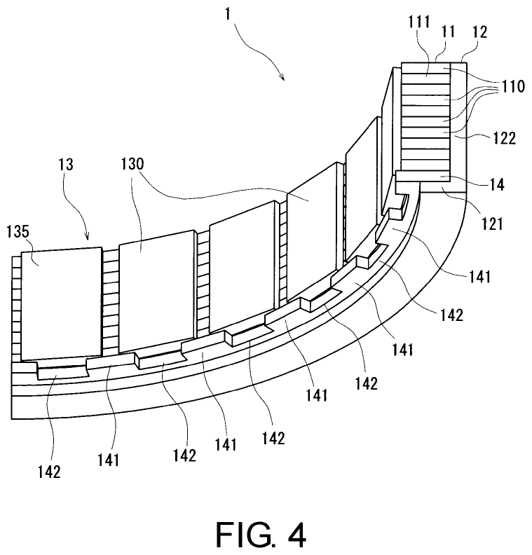

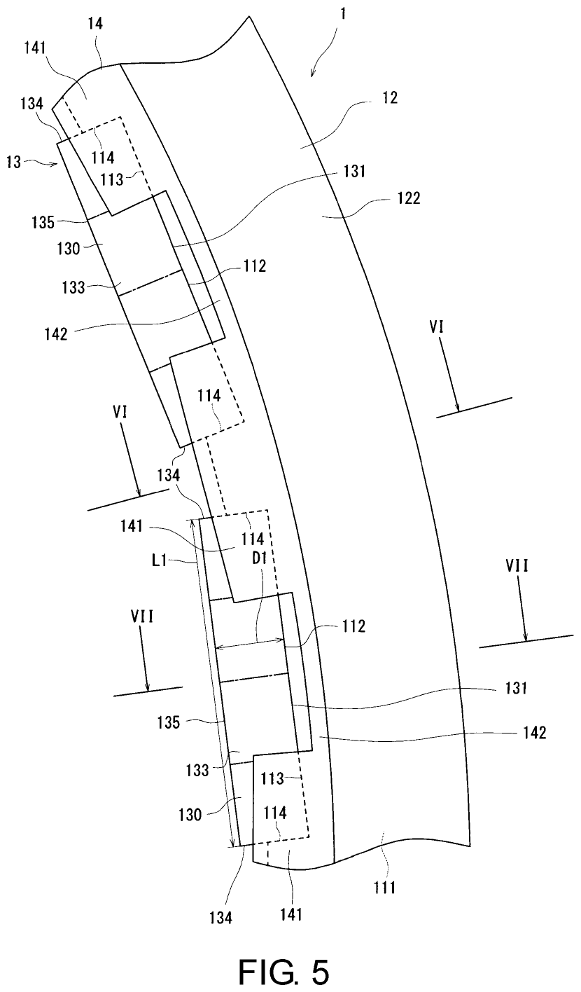

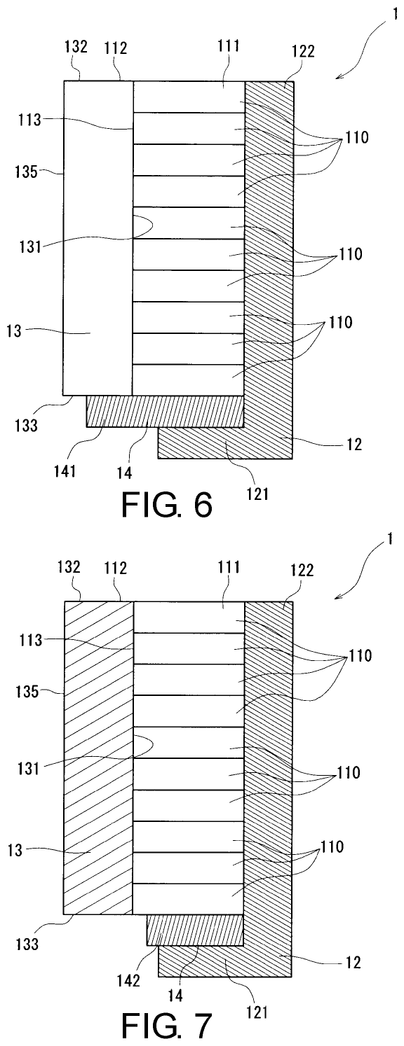

FIG. 3 is an exploded perspective view of the rotor 1. FIG. 4 is a perspective view of a part of the rotor 1 as viewed from below. FIG. 5 is an enlarged bottom view of the rotor 1. FIG. 6 is a cross-sectional view of the rotor 1 shown in FIG. 5 taken along the VI-VI line. FIG. 7 is a cross-sectional view of the rotor 1 shown in FIG. 5 taken along the VII-VII line. The rotor 1 includes the rotor core 11, the rotor housing 12, the rotor magnet 13, and the shield member 14.

<4.1.1 Regarding the Rotor Magnet 13>

As shown in FIG. 3 and FIG. 4, the rotor magnet 13 includes a plurality of magnet pieces 130. The magnet pieces 130 are arranged in the rotor housing 12 in the circumferential direction. Here, in the rotor magnet 13, a plurality of magnetization regions magnetized with different polarities are alternately disposed in the circumferential direction. Further, in the rotor magnet 13 used in the rotor 1 of the embodiment, the magnet pieces 130 are disposed side by side at equal intervals in the circumferential direction. That is, the rotor magnet 13 is segmented into the plurality of magnet pieces 130 disposed in the circumferential direction.

As shown in FIG. 5, the circumferential-direction length of a magnet lower surface 133 of the magnet piece 130 is referred to as a circumferential-direction length L1, and the radial-direction length thereof is referred to as a radial-direction length D1. The plurality of magnet pieces 130 are attached to the inner side surface of the rotor core 11. When the magnet piece 130 is attached to a groove part 112 of the rotor core 11, the side surface facing the radial-direction outer side is referred to as a magnet outer side surface 131, and the surface facing the axial-direction upper side is referred to as a magnet upper surface 132, and the surface facing the axial-direction lower side is referred to as a magnet lower surface 133, and the surfaces facing the circumferential direction are referred to as magnet circumferential side surfaces 134. Further, the side surface facing the radial-direction inner side is referred to as a magnet inner side surface 135.

The magnet piece 130 has magnetic poles with different polarities (N pole or S pole) on each of the magnet outer side surface 131 and the magnet inner side surface 135. Therefore, in the magnet piece 130, the N pole side with respect to the center in the radial direction is set as an N pole magnetization region magnetized to the N pole. The S pole side is set as an S pole magnetization region magnetized to the S pole. Further, in the following description, when it is not necessary to distinguish between the magnetic polarities (N pole and S pole), the N pole magnetization region and the S pole magnetization region are collectively referred to as the magnetization regions.

As shown in FIG. 5, the position detection part 4 is disposed on the axial-direction lower side of the rotor magnet 13 and faces the rotor magnet 13 in the axial direction. Here, a linear Hall IC is adopted as the position detection part 4. The position detection part 4 outputs a circumferential-direction variation of a change in the axial-direction magnetic flux from the magnet pieces 130 as a signal. Then, the rotational direction (that is, the circumferential-direction position) of the rotor 1 is detected based on the signal output from the position detection part 4.

When the position of the rotor 1 is detected by a linear Hall IC, the position of the rotor 1 can be detected with high accuracy when the waveform of the signal detected by the position detection part 4 is a waveform close to a sine wave.

<4.1.2 Regarding the Rotor Core 11>

As shown in FIG. 3 and FIG. 4, the rotor core 11 surrounds the central axis Cx in a ring shape, and is configured by laminating a plurality of rotor pieces 110 made of electromagnetic steel plates or the like in the axial direction. The rotor core 11 is fixed by a fixing method such as caulking while overlapping the rotor pieces 110 in the axial direction. In this way, the rotor core 11 becomes a ring shape extending along the central axis Cx. The fixing of the rotor pieces 110 is not limited to caulking, and a fixing method such as adhesion or welding may be adopted. Further, the rotor core 11 is not limited to a laminated body, and may be a molded body formed by solidifying magnetic powder such as iron powder by sintering or the like.

As shown in FIG. 5, the rotor core 11 includes an annular part 111 and the groove parts 112. The annular part 111 is in a ring shape with the central axis Cx as the center. The groove parts 112 are formed in concave shapes that are recessed on the inner side surface of the annular part 111 toward the radial-direction outer side. The number of the groove parts 112 is the same as the number of the magnet pieces 130. The plurality of groove parts 112 are disposed in the circumferential direction with intervals from the adjacent groove parts 112. Here, the plurality of groove parts 112 are disposed at equal intervals in the circumferential direction.

The groove part 112 includes a groove part radial-direction side surface 113 facing the radial-direction inner side and a pair of groove part circumferential-direction side surfaces 114 facing the circumferential direction (with reference to FIG. 5). Further, in the embodiment, the groove part circumferential-direction side surfaces 114 are orthogonal to the groove part radial-direction side surface 113, but the disclosure is not limited thereto. For example, the pair of groove part circumferential-direction side surfaces 114 may respectively be inclined in directions away from each other with respect to the central axis Cx, or conversely, may respectively be inclined in directions closer to each other with respect to the central axis Cx.

As shown in FIG. 5, in the motor 200 of the embodiment, the groove part radial-direction side surface 113 of the rotor core 11 contacts the magnet outer side surface 131 of the rotor magnet 13. However, as long as the rotor magnet 13 can be firmly fixed to the groove parts 112, the groove part radial-direction side surface 113 and the magnet outer side surface 131 may be separated from each other. Even in this case, the groove part radial-direction side surface 113 and the magnet outer side surface 131 face each other in the radial direction. Details of attachment of the rotor magnet 13 to the rotor core 11 will be described later.

<4.1.3 Regarding the Shield Member 14>

The shield member 14 includes a plurality of shield parts 141 and a plurality of connecting parts 142. The number of the shield parts 141 and the number of the connecting parts 142 are the same as the number of the groove parts 112 of the rotor core 11. The shield member 14 is in a ring shape surrounding the central axis Cx, and the shield parts 141 protrude from the ring-shaped inner side surface toward the radial-direction inner side. The plurality of shield parts 141 are disposed side by side in the circumferential direction, and the adjacent shield parts 141 are connected by the connecting parts 142. The plurality of shield parts 141 and the plurality of connecting parts 142 are alternately disposed.

That is, the shield member 14 includes the plurality of shield parts 141 that face, in the axial direction, a part of the rotor magnet 13 on the one side of the axial direction of the rotor magnet 13, and includes the plurality of connecting parts 142 that connect the shield parts 141 adjacent in the circumferential direction to each other. The shield member 14 is in a ring shape in which the plurality of shield parts 141 and the plurality of connecting parts 142 are alternately disposed. Since the shield member 14 is in a ring shape, it is easy to attach to the rotor core 11. In this way, a manufacturing process can be simplified.

The shield member 14 is attached to the axial-direction lower end of the rotor core 11. As shown in FIG. 3 and FIG. 4, a part of the shield part 141 overlaps a part of the groove part 112 of the rotor core 11 in the axial direction. In this way, the shield part 141 faces, in the axial direction, a part of the magnetization regions of the magnet piece 130 attached to the groove part 112. Further, the connecting part 142 is disposed closer to the radial-direction outer side than the magnet outer side surface 131 of the magnet piece 130. That is, the connecting part 142 is disposed closer to the radial-direction outer side than the magnet outer side surface 131 of the rotor magnet 13. Further, details of the positional relationship between the shield part 141 and the magnet piece 130 will be described later.

The shield member 14 is configured by, for example, the same electromagnetic steel plate as the electromagnetic steel plate configuring the rotor piece 110 of the rotor core 11. In addition, the shield member 14 may be fixed by the same method as the fixing method (caulking or the like) when the plurality of rotor pieces 110 are laminated. The shield member 14 is configured by the same member as the rotor core 11. Further, the shield member 14 may be fixed by a fixing method different from the fixing method when the rotor pieces 110 are laminated. In addition, in the case where the rotor core 11 is a laminated body, when the shield member 14 is attached, the shield member 14 may be attached separately, or may be formed as a molded body integrally with a part of the rotor core 11 (that is, with the rotor core 11).

That is, the rotor 1 includes the rotor housing 12 which is in a cylindrical shape, and includes the rotor core 11 which is in a cylindrical shape, which is held in the inner part of the rotor housing 12 and which holds the rotor magnet 13 inside. The shield member 14 is the same member as the rotor core 11. Here, that the shield member 14 is the same member as the rotor core 11 includes, in addition to the case where the shield member 14 and the rotor core 11 are strictly formed integrally as described above, the case where the shield member 14 is formed by the same material as the rotor core 11 and the case where the shield member 14 is fixed and laminated by caulking, welding or the like. Moreover, the case where the materials are somewhat different may be included.

That is, it includes a state where the shield member 14 is fixed to the rotor core 11 and cannot be easily separated. Since the shield member 14 is formed by the same material as that of the rotor piece 110 of the rotor core 11, the types of materials can be reduced, and the manufacturing cost of the rotor 1 can be reduced.

<4.1.4 Regarding the Rotor Housing 12>

The rotor housing 12 is a holding member that holds the rotor core 11 inside. The rotor housing 12 is in a cylindrical shape and includes a housing bottom part 121 and a housing cylinder part 122.

The housing bottom part 121 is in an annular shape that is disposed on the axial-direction lower-side end part of the rotor housing 12 and expands in a direction orthogonal to the central axis Cx. The housing bottom part 121 contacts the axial-direction bottom surface of the shield member 14. The housing bottom part 121 contacts, in the axial direction, a part of the shield parts 141 and a part of the connecting parts 142 on the radial-direction outer side of the connecting parts 142.

The housing cylinder part 122 is a cylinder body that extends from the radial-direction outer-side edge part of the housing bottom part 121 toward the axial-direction upper side. The housing cylinder part 122 contacts the radial-direction outer side surfaces of the shield member 14 and the rotor core 11 to fix the shield member 14 and the rotor core 11. In addition, the fixing method of the housing cylinder part 122, the shield member 14, and the rotor core 11 may include, for example, press fitting, but it is not limited thereto. For example, a wide range of methods, such as adhesion or welding, that can fix the housing cylinder part 122, the shield member 14, and the rotor core 11 can be adopted.

<4.1.5 Regarding the Assembly of the Rotor 1>

As shown in FIG. 3, first, the rotor pieces 110 are laminated in the axial direction. At this time, the rotor pieces 110 are caulked and laminated in a state where the concave parts of the rotor pieces 110 overlap in the axial direction. The rotor 1 is formed in a ring shape which includes the groove parts 112, surrounds the central axis Cx and is laminated in the axial direction. Then, the shield member 14 is fixed by caulking on the axial-direction lower side of the rotor 1.

Next, each magnet piece 130 is attached, via an adhesive member, to each groove part 112 of the rotor 1 to which the shield member 14 is attached. That is, the magnet pieces 130 adjacent in the circumferential direction are disposed with gaps therebetween. In this way, the short circuit among the magnetic flux of the magnet pieces 130 can be suppressed, and the decrease of the magnetic force can be suppressed. In this way, the material cost of the rotor magnet 13 can be reduced. Further, the circumferential-direction positioning of the rotor magnet 13 is easy.

Next, the rotor core 11 to which the magnet pieces 130 and the shield member 14 are attached is attached to the inner part of the rotor housing 12. The attachment of the rotor core 11 to the rotor housing 12 is fixed by a conventionally well-known fixing method, such as press fitting, adhesion, or welding.

<4.1.6 Regarding a Modified Example>

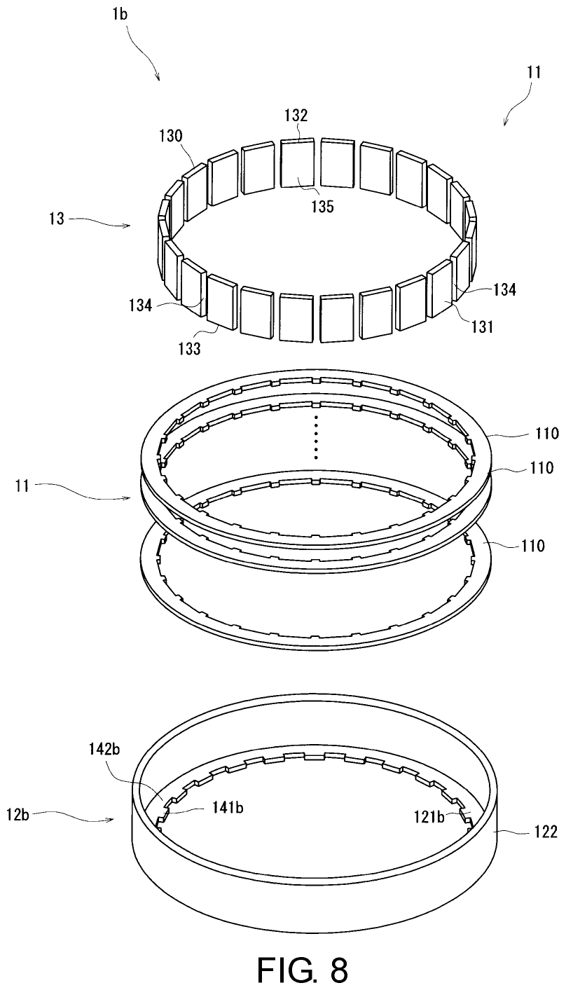

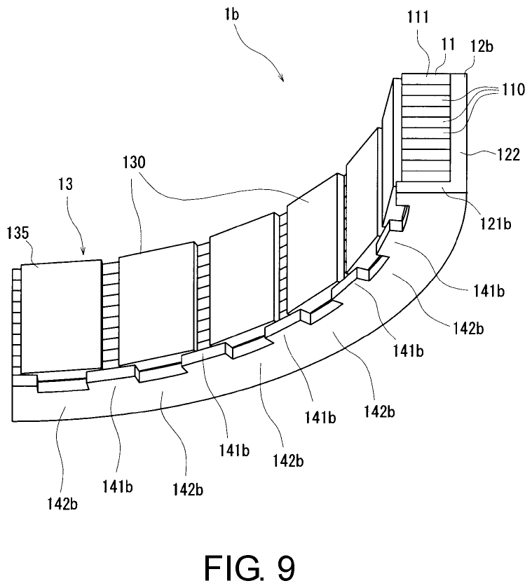

A rotor 1b of a modified example will be described with reference to the drawings. FIG. 8 is an exploded perspective view of the rotor 1b according to a modified example of the embodiment. FIG. 9 is a perspective view of a part of the rotor 1b shown in FIG. 8 as viewed from below. As shown in FIG. 8 and FIG. 9, the rotor 1b has a configuration in which the shield member 14 is omitted, and has a configuration in which there is a shield member 14b including the shield parts 141b and the connecting parts 142b on the housing bottom part 121b of the rotor housing 12b. Except for this point, the configuration of the rotor 1b is the same as that of the rotor 1, and the parts in which the rotor 1b is substantially the same as the rotor 1 are denoted by the same reference numerals, and detailed descriptions of the same parts are omitted.

The rotor 1 includes the rotor housing 12b which is in a cylindrical shape, and includes the rotor core 11 which is in a cylindrical shape, which is held in the inner part of the rotor housing 12b and which holds the rotor magnet 13 inside, and the shield member 14b is the same member as the rotor housing 12b. Since the shield member 14b is formed by the same member as the rotor housing 12b as described above, the number of components can be reduced. Moreover, the assembly of the rotor 1b is easy. Further, a mold for the shield member 14b can be omitted, and a pressing step for molding the shield member 14b can be omitted.

<4.2 Regarding the Stator 2>

Next, the stator 2 will be described. The stator 2 faces the rotor 1 in the radial direction. The stator 2 is an armature that causes generation of a magnetic flux according to a driving current. As shown in FIG. 2, the stator 2 includes the stator core 21, an insulator 22, and a coil 23.

The stator core 21 is a magnetic body. The stator core 21 is configured, for example, by laminating electromagnetic steel plates in the axial direction. The stator core 21 includes a core back part 211 in a cylindrical shape extending along the central axis Cx and a plurality of teeth parts 212. As shown in FIG. 2, the core back part 211 in an annular shape is fixed to the supporting column 100 while the supporting column 100 is inserted into a through hole provided in the central part. For example, the supporting column 100 is fixed to the through hole by press fitting. However, the fixing of the core back part 211 to the supporting column 100 is not limited to press fitting, and a wide range of methods, such as adhesion or welding, that can reliably fix the core back part 211 to the supporting column 100 can be used.

The insulator 22 is, for example, disposed so as to surround the teeth parts 212. The coil 23 is formed by winding a conductive wire around the teeth parts 212 surrounded by the insulator 22. The coil 23 is magnetically excited by a current supplied to the conductive wire. In the motor 200, the rotor 1 is rotated by the attractive force and the repulsive force of the coil 23 and the rotor magnet 13.

<5. Regarding the Operation of the Motor 200>

As shown in FIG. 2, the rotor 1 is attached to the rotor attachment part 307 of the impeller housing 301. In addition, the attachment of the rotor 1 to the rotor attachment part 307 may be fixed by press-fitting the housing cylinder part 122 of the rotor housing 12 into the rotor attachment cylinder part 309 of the rotor attachment part 307, or may be fixed by a fixing method such as adhesion or welding.

Then, after the circuit board 40 is attached to the base part 101 of the supporting column 100, the stator 2 is attached to the supporting column 100. Then, the impeller housing 301 is attached to the supporting column 100, to which the stator 2 and the circuit board 40 are attached, via the bearings 3 in a rotatable state. At this time, the position detection part 4 mounted on the circuit board 40 faces the magnet lower surfaces 133 of the rotor magnet 13 (the magnet pieces 130) in the axial direction. Further, the magnet inner side surfaces 135 facing the radial-direction inner side of the rotor magnet 13 (the magnet pieces 130) face the teeth parts 212 of the stator 2 in the radial direction.

The magnetic force of the magnet pieces 130 of the rotor magnet 13 extending in the circumferential direction will be described. The rotor magnet 13 has a shape in which the plurality of magnet pieces 130 in rectangular parallelepiped shapes are arranged in the circumferential direction. Further, the magnet piece 130 includes magnetization regions with different polarities on the radial-direction inner side and the radial-direction outer side. Assuming that the direction of the magnetic force is from the N pole to the S pole, the magnet piece 130 forms a magnetic force from the N pole magnetization region to the S pole magnetization region among the magnetization regions of different polarities of the adjacent magnet pieces 130.

For example, in the rotor magnet 13 shown in FIG. 5, a magnetic force is formed from the magnet piece 130 whose N pole faces the outer side to the outer-side S pole of the adjacent magnet piece 130. Then, the axial-direction magnetic flux is large in the part close to the magnetic poles and is small in the part between the adjacent magnet pieces 130. That is, in each magnet piece 130, the axial-direction magnetic flux increases at the central part in the circumferential direction.

Further, in the motor 200 of the embodiment, the shield parts 141 absorb the magnetic force which comes out from the boundary parts of the adjacent magnet pieces 130. In this way, the axial-direction magnetic flux in the rotor magnet 13 is reduced at the boundary parts of the magnet pieces 130. The surface of the shield part 141 that faces the magnet lower surface 133 in the axial direction is a region that is larger than ¼ of the circumferential-direction length of the magnet lower surface 133 from the end part of the magnet lower surface 133. Therefore, the axial-direction magnetic flux is reduced in a region larger than ¼ of the circumferential-direction length of the magnet lower surface 133 from the circumferential-direction end part of the magnet lower surface 133.

Next, the magnetic force of the magnet pieces 130 of the rotor magnet 13 generated in the radial direction will be described. The magnet piece 130 includes magnetization regions magnetized by different magnetic poles in the radial direction. Therefore, on the magnet lower surface 133 of the magnet piece 130, a magnetic force is generated from the N pole magnetization region to the S pole magnetization region. In the magnet piece 130, the magnetization regions of different magnetic poles are disposed side by side in the radial direction.

Therefore, in the magnet piece 130, the axial-direction magnetic flux is large in the part far from the boundary of the magnetization regions (that is, the magnet outer side surface 131 side and the magnet inner side surface 135 side), and the magnetic field lines are formed from the radial-direction outer side to the radial-direction inner side or from the radial-direction inner side to the radial-direction outer side.

As shown in FIG. 5 and FIG. 6, a part of the shield part 141 of the shield member 14 faces a part of the magnet lower surface 133 of the magnet piece 130 in the axial direction. That is, the rotor 1 further includes the shield member 14, and the shield member 14 faces, in the axial direction, a part of the rotor magnet 13 on the one side of the axial direction of the rotor magnet 13. In addition, in the rotor 1 included in the motor 200 of the embodiment, a part of the shield part 141 and a part of the magnet lower surface 133 are in contact in the axial direction. That is, the shield member 14 contacts a surface of the rotor magnet 13 on the one side of the axial direction of the rotor magnet 13.

By adopting a configuration in which the rotor magnet 13 contacts the shield member 14, the axial-direction position of the rotor magnet 13 is stabilized, and its distance from the position detection part 4 is stabilized. In this way, the detection accuracy of the position of the rotor 1 can be improved.

Therefore, the magnet piece 130 is firmly fixed to the groove part 112. When the magnet piece 130 is fixed via an adhesive member, the circumferential-direction length of the groove part circumferential-direction side surface 114 is longer than the circumferential-direction length of the magnet piece 130 by the gap where the adhesive member is interposed. In this way, the rotor magnet 13 is firmly fixed to the rotor core 11 by the adhesive member. Further, the circumferential-direction length of the magnet piece 130 and the circumferential-direction length of the groove part 112 may be the same. In this case, when the magnet piece 130 is attached to the groove part 112, the magnet circumferential side surfaces 134 contact the groove part circumferential-direction side surfaces 114. In this way, the magnet piece 130 can be firmly fixed without interposing an adhesive member.

In the rotor 1, the shield member 14 is disposed between the magnet pieces 130 and the position detection part 4. The position detection part 4 detects the magnetic flux that has been partially absorbed and modified by the shield member 14. Further, the connecting part 142 is disposed closer to the radial-direction outer side than the magnet outer side surface 131 of the magnet piece 130. That is, the connecting part 142 is disposed closer to the radial-direction outer side than the magnet outer side surface 131 of the rotor magnet 13. In this way, the short circuit of the magnetic flux from the rotor magnet 13 to the connecting part 142 is suppressed. In this way, the decrease of the magnetic flux which goes from the rotor magnet 13 in the axial direction can be suppressed. Further, the configuration of the connecting part 142 is adopted in the case of the outer rotor type motor 200, but it may also be adopted in the case where the motor is an inner rotor type. That is, the stator 2 may face the outer circumferential surface of the rotor 1 in the radial direction, and the connecting part 142 may be disposed closer to the radial-direction inner side than the inner side surface of the rotor magnet 13. By adopting such a configuration, the same effect can be achieved.

Next, the variation in the magnetic flux detected by the position detection part 4 is described. In the motor 200 of the embodiment, the shield parts 141 absorb the magnetic flux which comes out from the boundary parts of the adjacent magnet pieces 130. The axial-direction magnetic flux in the rotor magnet 13 is reduced at the boundary parts of the magnet pieces 130.

Here, the positions of the shield member 14 and the magnet lower surface 133 will be described in more detail. As shown in FIG. 5, the shield part 141 faces the axial-direction lower side of two adjacent ends of the magnet pieces 130 adjacent in the circumferential direction. As shown in FIG. 5, the circumferential-direction length of a part of the shield part 141 overlapping the magnet piece 130 in the axial direction is greater than ¼ of the magnet piece 130 on one side. The shield part 141 faces, in the axial direction, each of the magnet pieces 130 adjacent in the circumferential direction. That is, the shield member 14 faces, in the axial direction, a part of each of the magnetization regions having different polarities adjacent in the circumferential direction of the rotor core 11. That is, the shield member 14 faces, in the axial direction, a part of each of the magnetization regions having different polarities adjacent in the circumferential direction.

In this way, the axial-direction magnetic flux density of the magnetic force going in the circumferential direction decreases at the boundary parts of the magnet pieces 130.

That is, in the motor 200 of the embodiment, the shield member 14 absorbs the magnetic flux moderately, and the signal based on the magnetic flux detected by the position detection part 4 can be modified to a shape close to a sine wave. In this way, the position of the rotor 1 can be detected with high accuracy, and the rotation control of the motor 200 can be performed with high accuracy.

More specifically, a part of ¼ or more of the circumferential-direction length from the two circumferential-direction ends of the magnet piece 130 faces the shield parts 141 in the axial direction. That is, the circumferential-direction length of the part of the shield member 14 facing, in the axial direction, the magnetization regions of the magnet pieces 130 is half or more of the circumferential-direction length of the magnetization regions. By adopting such a configuration, the magnetic flux can be moderately absorbed in the circumferential direction. In this way, the signal based on the magnetic flux detected by the position detection part 4 can be modified to a shape close to a sine wave. Therefore, the position of the rotor 1 can be detected with high accuracy, and the rotation control of the motor 200 can be performed with high accuracy.

The surface of the shield part 141 that faces the magnet lower surface 133 in the axial direction is a region that extends from the radial-direction outer-side end part of the magnet lower surface 133 closer to the radial-direction inner side than the central part (the part in half) of the radial-direction length of the magnet lower surface 133. In addition, the shield part 141 reduces the magnetic flux. At this time, the radial-direction magnetic field lines are reduced in the part where the shield part 141 is provided. Since the shield parts 141 are disposed at the boundary parts of the magnet pieces 130 arranged in the circumferential direction, the magnetic force formed in the radial direction is also reduced at the circumferential-direction boundary parts of the magnet pieces 130. That is, the radial-direction length of the part of the shield member 14 facing the magnetization regions in the axial direction is half or more of the radial-direction length of the rotor magnet 13.

The shield parts 141 faces, in the axial direction, a part of the magnetization regions of the magnet pieces 130 attached to the rotor core 11, and a part of the axial-direction magnetic flux from the magnetization regions of the magnet pieces 130 is absorbed. In this way, the axial-direction magnetic flux of the part of the magnet pieces 130 facing the shield parts 141 in the axial direction is reduced. In this way, the signal based on the magnetic flux detected by the position detection part 4 can be made close to a sine wave by moderately absorbing the axial-direction magnetic flux generated by the radial-direction magnetic force. In this way, the position of the rotor 1 can be detected with high accuracy, and the rotation control of the motor 200 can be performed with higher accuracy.

As described above, in the motor 200 according to the disclosure, the shield member 14 is disposed between the rotor magnet 13 and the position detection part 4, whereby a part of the magnetic flux from the rotor magnet 13 toward the position detection part 4 can be absorbed by the shield member 14. In this way, when the rotor 1 rotates, the signal based on the change in the magnetic flux detected by the position detection part 4 becomes close to a sine wave. Therefore, without changing the shape of the rotor magnet 13 (the magnet pieces 130), the signal based on the change in the magnetic flux detected by the position detection part 4 can be made close to a sine wave, and the position of the rotor 1 can be detected accurately. In this way, the accuracy of controlling the motor 200 can be improved.

Further, in the case of the configuration in which the plurality of magnet pieces 130 are disposed side by side in the circumferential direction, the rotor magnet 13 is not in an annular shape but is in a polygonal shape when viewed in the axial direction. Since the rotor 1 rotates around the central axis Cx, when the rotor magnet 13 is in a polygonal shape, the distance between the magnet lower surface 133 of the magnet piece 130 and the position detection part 4 changes. In such a configuration, by using the shield member 14, the change in the magnetic flux detected by the position detection part 4 can be made close to a sine wave, and the position of the rotor 1 can be accurately detected.

In addition, though the rotor magnet 13 of the embodiment is a configuration which can be segmented into the plurality of magnet pieces 130, the disclosure is not limited thereto. For example, a rotor magnet in which different magnetic poles are alternately magnetized in the circumferential direction of a cylindrical-shaped body formed by sintering or the like may be used. In this case as well, by using a shield member with shield parts that cover a part of each of the adjacent magnetization regions on the end face of the rotor magnet on the position detection part side, it is possible to obtain a signal with a waveform necessary for position detection by the position detection part.

In addition, the motor according to the disclosure can be widely used not only in an air blowing device but also as a power source for rotating a rotating body.

The embodiments of the disclosure have been described above, but the disclosure is not limited to the above contents. Further, various modifications can be added to the embodiments of the disclosure without departing from the spirit of the disclosure.

### INDUSTRIAL APPLICABILITY

The air blowing device of the disclosure can be used for a circulator. Further, for example, it can be used as a power source for an unmanned air vehicle. In addition to this, the disclosure can be widely applied to machines which use an airflow that generates an axial flow. Moreover, the motor of the disclosure can be used as a power source which supplies a rotational force to the outside other than to an air blowing device.

What is claimed is:

1. A motor, comprising:
a rotor which is rotatable with a central axis that extends vertically as a center and in which a rotor magnet is disposed;
a stator which faces the rotor in a radial direction; and
a position detection part which is located on one side of an axial direction of the rotor magnet and which detects a magnetic flux of the rotor magnet,
wherein in the rotor magnet, a plurality of magnetization regions magnetized with different polarities are alternately disposed in a circumferential direction, and
the rotor comprises a shield member which faces, in an axial direction, a part of the rotor magnet on the one side of the axial direction of the rotor magnet.

2. The motor according to claim 1, wherein the rotor magnet is segmented into a plurality of magnet pieces disposed in the circumferential direction.

3. The motor according to claim 2, wherein the magnet pieces adjacent in the circumferential direction are disposed with gaps therebetween.

4. The motor according to claim 1, wherein the shield member contacts a surface of the rotor magnet on the one side of the axial direction of the rotor magnet.

5. The motor according to claim 1, wherein the shield member faces, in the axial direction, a part of each of the magnetization regions having different polarities adjacent in the circumferential direction.

6. The motor according to claim 5, wherein a circumferential-direction length of a part of the shield member facing the magnetization regions in the axial direction is half or more of a circumferential-direction length of the magnetization regions.

7. The motor according to claim 5, wherein a radial-direction length of a part of the shield member facing the magnetization regions in the axial direction is half or more of a radial-direction length of the rotor magnet.

8. The motor according to claim 1, wherein the rotor comprises:
a rotor housing which is in a covered cylindrical shape; and
a rotor core which is in a cylindrical shape, which is held in an inner part of the rotor housing, and which holds the rotor magnet inside, and
the shield member is a same member as the rotor core.

9. The motor according to claim 1, wherein the rotor comprises:
a rotor housing which is in a covered cylindrical shape; and
a rotor core which is in a cylindrical shape, which is held in an inner part of the rotor housing, and which holds the rotor magnet inside, and
the shield member is a same member as the rotor housing.

10. The motor according to claim 1, wherein the shield member comprises:
a plurality of shield parts which face, in the axial direction, a part of the rotor magnet on the one side of the axial direction; and
a plurality of connecting parts which connect the shield parts adjacent in the circumferential direction to each other, and
the shield member is in a ring shape in which the plurality of shield parts and the plurality of connecting parts are alternately disposed.

11. The motor according to claim 10, wherein the stator faces an inner circumferential surface of the rotor in the radial direction, and
the connecting part is disposed closer to a radial-direction outer side than an outer side surface of the rotor magnet.

12. The motor according to claim 10, wherein the stator faces an outer circumferential surface of the rotor in the radial direction, and
the connecting part is disposed closer to a radial-direction inner side than an inner side surface of the rotor magnet.

13. An air blowing device, comprising:
the motor according to claim 1; and
an impeller fixed to the rotor.
